(19) United States
(12) Patent Application Publication
(10) Pub. No.: US 2017/0011717 A1
(43) Pub. Date: Jan. 12, 2017

(54) LIGHTWEIGHT ELECTRIC GUITAR

(71) Applicant: Sang Kil KIM, Gyeonggi-do (KR)

(72) Inventor: Sang Kil KIM, Gyeonggi-do (KR)

(21) Appl. No.: 15/113,069

(22) PCT Filed: Jan. 20, 2015
(86) PCT No.: PCT/KR2015/000572

§ 371 Date: Jul. 21, 2016

(30) Foreign Application Priority Data
Jan. 21, 2014 (KR) 10-2014-0007095

(51) Int. Cl. G10D 1/08; G10D 3/06

(52) U.S. Cl. CPC G10D 1/085; G10D 3/06

(57) ABSTRACT

The objective of the present invention is to provide a lightweight electric guitar in which the body and neck are made, in a hollow form, of a magnesium alloy, and in which the neck is detachably and attachably assembled with the body, thereby reducing the weight of the electric guitar and enabling the neck to be easily separated from the body for replacement or repair. In particular, the objective of the present invention is to provide a lightweight electric guitar in which the body and neck part are made to be hollow and the interior is processed to be a vacuum, thereby increasing the echo of sound to absorb unwanted noise and the like and enabling generation of a high quality level of sound.

### TECHNICAL FIELD

The present invention relates to a lightweight electric guitar, and in particular to a lightweight electric guitar wherein a body and a neck are made, in hollow forms, of a magnesium alloy, whereupon an electric guitar is light and can be freely designed, and has a good sound absorption power, and the neck does not easily deform and can be easily exchanged or repaired.

### BACKGROUND ART

An electric guitar, in general, is configured to generate vibrations when a user strikes strings. A pickup device having a microphone function converts the vibrations into an electric signal, and the electric signal is converted into sounds, thus playing a predetermined music.

This electric guitar is able to transfer a desired sound to the pickup device lest unnecessary noises, etc. are mixed when striking the strings. The patent document (Korean patent registration No. 1183071) describes an electric guitar which is made of a magnesium alloy having a good sound absorption function.

In the aforementioned electric guitar of the patent document, since a main body and a neck unit are made of a magnesium alloy wherein a lightness, a shielding property, a heat radiation performance, and a vibration damping capacity are good, it is possible to manufacture an electric guitar which is able to generate a high quality sound in such a way to absorb unnecessary sounds, while reducing the whole weight of the electric guitar.

The aforementioned conventional electric guitar, however, has the following problems.

(1) The main body and the neck unit are made integrate. If the neck unit has a problem or it needs to exchange the neck unit after it has collided with a hard portion and has been deformed, the whole parts of the main body and the neck unit should be inevitably exchanged.

(2) Even though a part of the electric guitar has a problem, the whole parts of the electric guitar should be exchanged, which may be a cause for an inefficiency and an increased cost.

(3) Since the main body is made in the form of one lump, a lightness, a shielding property, a heat radiation performance, and a vibration damping capacity are good thanks to the characteristics of a magnesium alloy of the main body, but the weight of the electric guitar itself becomes heavy.

(4) The conventional electric guitar is hard to play with for a long time, and is hard to carry with hands.

### DISCLOSURE OF INVENTION

Accordingly, the present invention is made in an effort to resolve the aforementioned problems. It is a first object of the present invention to provide a lightness electric guitar wherein a body and a neck are made, in hollow forms, of a magnesium alloy, and the neck is assembled detachable to the body, by means of which the weight of the electric guitar can be reduced, and the neck can be easily separated from the body when it needs to exchange or repair the neck, thus providing a lightness electric guitar.

It is another object of the present invention to provide a lightness electric guitar wherein the insides of the body and the neck made in the hollow forms are made to have vacuums, by which it is possible to absorb unnecessary noises, etc. by increasing the echo of a sound, thus producing a standard high acoustic.

To achieve the above objects, according to a first embodiment of the present invention, there is provided a lightness electric guitar, which may include, but is not limited to, a body 100 which is made of a magnesium alloy and in a hollow form 150 by a die casting method and is equipped with a bridge assembly 110, a pickup 120 and an adjusting unit 130 all disposed at one side thereof, and a neck engaging unit 140 disposed at another side thereof; a neck 200 which is made, in a hollow form 220, of a magnesium alloy and is installed detachable at the neck engaging unit 140; and a fingerboard 300 which is mounted on the neck 200.

In particular, the surfaces of the body 100 and the neck 200 are plated with a nickel material.

Moreover, the body 100 and the neck 200 are manufactured by a MCT (Machining Center Tooling) processing method.

Furthermore, the insides of the body 100 and the neck 200 are processed to have vacuums.

In addition, the neck 200 is engaged detachable using screws or bolts and nuts.

Finally, in the electric guitar according to a second embodiment of the present invention, the neck 200 may include a head 210 which is engaged detachable, using screws or bolts and nuts, to the neck 200.

### ADVANTAGEOUS EFFECTS OF THE INVENTION

The lightness electric guitar according to the present invention has the following advantageous effects.

(1) Since a neck can be separated from a body, the neck can be easily separated and repaired or exchanged if the neck is broken or when it needs to repair or exchange.

(2) Since the neck can be separated from the body, it is possible to exchange or repair a body or a neck when it needs an exchange or a repair, whereupon it does not need to exchange or discard all the parts of the electric guitar which actually don't need any exchange or repair.

(3) Since the body and the neck are made in hollow forms, the entire weights of the electric guitar according to the present invention can be reduced.

(4) When an electric guitar player plays for a long time with an electric guitar hung on his shoulder, any weight that the player receives can be reduced. Anyone can easily play a light electric guitar on his shoulder.

(5) In particular, the hollow portions of the body and the neck are made to have vacuums, which makes it possible to enhance a sound echo effect, by which it is possible to produce acoustic which is different from the acoustic generated by a typical electric guitar.

(6) The body and the neck can be manufactured by a die casting method, so they can be mass-produced. The quality of the product can be enhanced through a precise manufacturing process which can be carried out by a MCT (Machining Center Tooling) device.

(7) The hollow portion formed in the body may allow to provide a decreased weight of the electric guitar, while providing the sound box function of a common guitar, for example, a nylon guitar. The sound range of the electric guitar according to the present invention can be increased, so acoustic effects can be enhanced.

### BRIEF DESCRIPTION OF DRAWINGS

FIG. 1 is a perspective view illustrating an assembled state of an electric guitar according to a first embodiment of the present invention.

FIG. 2 is a disassembled perspective view illustrating a state where a part of the electric guitar is disassembled so as to show a space formation at a portion of the body of the electric guitar according to a first embodiment of the present invention.

FIG. 3 is a disassembled perspective view illustrating the whole configuration of an electric guitar according to a first embodiment of the present invention.

FIG. 4 is a disassembled perspective view illustrating the whole configuration of an electric guitar according to a second embodiment of the present invention.

### BEST MODES FOR CARRYING OUT THE INVENTION

The preferred embodiments of the present invention will be described with reference to the accompanying drawings. The terms or words used throughout this specification and claims should not be interpreted as being limited to typical or dictionary meanings, but should be interpreted as having the meaning and concept matching with the technical concepts of the present invention based on a principle where an inventor can appropriately define the concepts of such terms so as to describe in the best way his invention.

For this reason, the configurations described in conjunction with the embodiments of this specification and illustrated in the drawings correspond to just the most preferred embodiments of the present invention, not representing all the technical concepts of the present invention, whereupon it should be understood that there may be a variety of equivalents and modifications which may be substituted with such configurations at the time the present invention is filed.

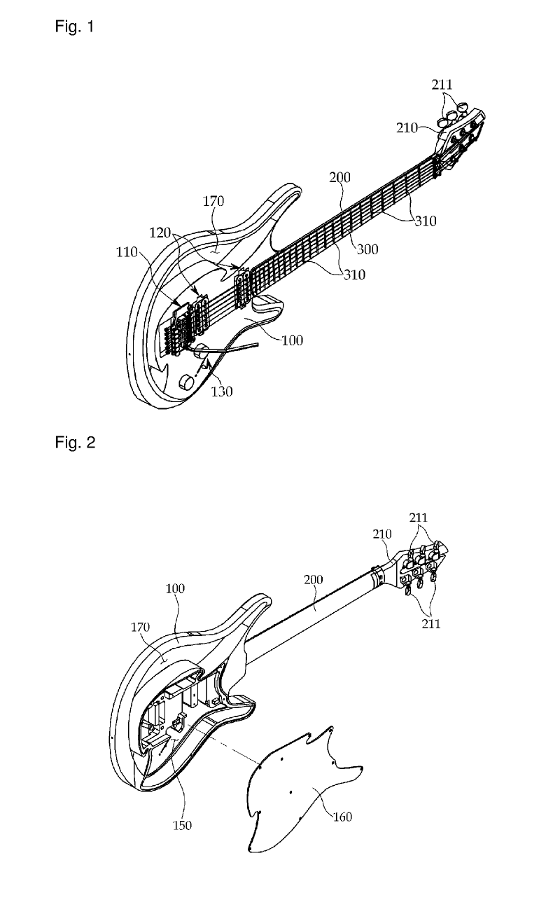

As illustrated in FIGS. 1 to 3, the electric guitar according to a first embodiment of the present invention may include, but is not limited to, a body 100 and a neck 200 which are made by a die casting method of a magnesium alloy, and a fingerboard 300 which is attached to a side of the neck 200.

The insides of the body 100 and the neck 200 are made in the hollow forms (150 and 220), by which the weight of the electric guitar can be reduced, so a player's fatigue can be reduced if he plays for a long time with the electric guitar hung on his shoulder. If the body 100 or the neck 200 is broken or needs an exchange, only a part which belongs to such a problem, can be selectively exchanged and then used.

Since the hollow portions of the body 100 and the neck 200 are made to have vacuums, sound cannot transfer through the vacuums, unnecessary sounds can be blocked from transferring, thus enhancing an echoing effect of the sound.

The aforementioned configurations of the lightness electric guitar according to the present invention will be described in more detail.

As illustrated in FIGS. 1 to 3, the body 100 is manufactured to have a predetermined size, and the body 100 is manufactured by a die casting method using a magnesium alloy as a raw material.

The magnesium alloy is able to provide a lightness, a shielding property, a heat radiation performance, and a vibration damping capacity, so the whole weights of the electric guitar according to the present invention can be reduced. Moreover, it is able to provide a high damping capacity with respect to vibrations, thus decreasing nearby noises, so the magnesium alloy is able to provide a good effect to improve acoustic.

Moreover, the body 100 according to a first embodiment of the present invention is made, by a die casting method, of a magnesium alloy. For this reason, the body 100 can be easily manufactured. Moreover, it can be manufactured into various forms after a corresponding mold has been made. In terms of designs, it can be manufactured in various shapes.

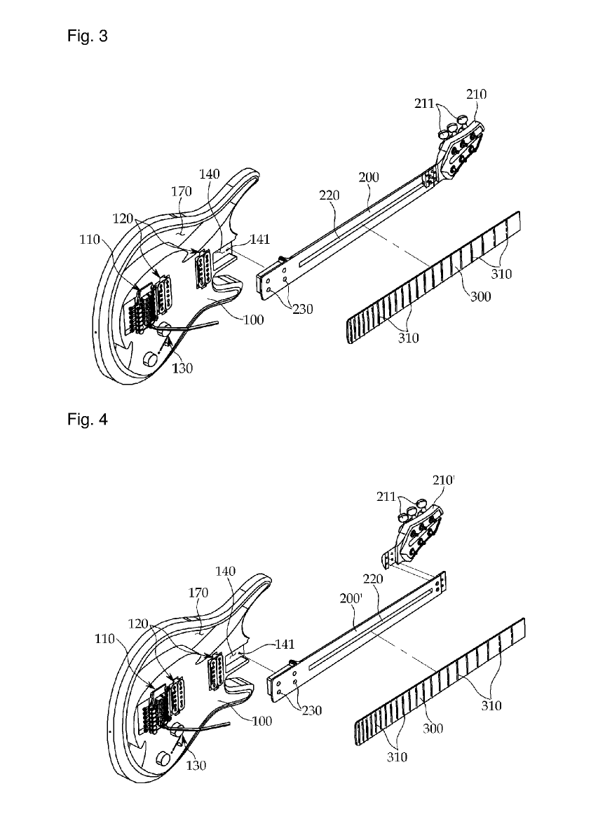

Furthermore, as illustrated in FIG. 2, the inside of the body 100 according to a first embodiment of the present invention is made in the form of a vacuum. This configuration may allow a player to more comfortably play an electric guitar even though he plays for a long time since the whole weight of the electric guitar is reduced by decreasing the entire weight of the body 100. FIG. 3 shows an occasion wherein the body 100 is made in a container shape, and a cover 160 is covered on the body 100 and is fixedly engaged thereto.

In the preferred embodiment of the present invention, the inside of the hollow body 100 can be made in the form of a vacuum. Since sound does not transfer via the vacuum, any sound, noise, etc. which generate as the strings are struck, can be blocked from transferring via the body 100, whereupon the echoing effects of sound can be enhanced. The aforementioned vacuum state can be formed in such a way that a nipple, etc. is engaged to a hollow portion and is connected to the outside, and a vacuuming device is connected to the nipple. In this state, the air inside the hollow portion can be discharged to the outside of the body 100, thus easily making a vacuum state.

Moreover, in the preferred embodiment of the present invention, it is preferred that the body 100 can be made into various shapes using a MCT device. The MCT stands for a “Machining Center Tooling System” which is equipped with a CNC concept. More specifically, it may represent a processing machine which can be manufactured by a typical technology and may have a computerized numerical control for the sake of a drilling work. Using the aforementioned processing device, it is possible to process the body 100 into various shapes and patterns, while matching with various designs, in such a way to use a combination of plane and curved surfaces.

Furthermore, in the preferred embodiment of the present invention, it is preferred that a nickel is plated on the surface of the body 100 which is made of a magnesium alloy, by which a variety of decoration effects can be obtained while enhancing the wear resistance of the surface of the body 100.

Finally, in the preferred embodiment of the present invention, it is preferred that a cavity part 170 is formed by cutting through a predetermined portion which is unnecessary in the body 100. In this way, the entire design of the body 100 can have a different aesthetic sensibility thanks to the shapes of the cavity part 170 while reducing the weight of the body 100.

As illustrated in FIGS. 1 and 3, the thusly configured body 100 may be equipped with a bridge assembly 110, a pickup 120, an adjusting unit 130, and a neck engaging unit 140.

The bridge assembly 110 is employed to fix the strings, and the pickup 120 is a converter which is able to convert the strikes of the strings into electric signals (for example, the intensity of current), and the adjusting unit 130 may have a typical function to adjust acoustics.

Moreover, as illustrated in FIG. 3, the neck engaging unit 140 is employed to install the neck 200 which will be described later. A plurality of engaging holes 141 may be previously formed at regular intervals, so the neck 200 can be engaged detachable using screws, bolts and nuts, etc.

As illustrated in FIGS. 1 to 3, the neck 200 is able to support the whole portions of the fingerboard 300 which will be described later, and a hollow portion 220 may be formed inside of the neck 200.

The neck 200 may be made, by a die casting method, of a magnesium alloy. The manufacturing of the neck 200, the hollow portion 220 formed inside thereof, the nickel plating, the vacuum at the hollow portion and the MCT processing may be carried out by the same method as in the body 100. The detailed description thereon will be omitted.

As illustrated in FIG. 3, the neck 200 may include engaging holes 230 at the portions opposite the engaging holes 141 formed at the neck engaging unit 140. The neck 200 can be fixedly engaged to the engaging hole using screws or bolts, etc. It is preferred that the screws or bolts are hid behind the fingerboard 300, so they are not exposed to the outside.

If the neck 200 is deformed by an external impact, etc. or if it needs to exchange the neck 200 due to wear, the neck 200 can be exchanged with a new neck or can be repaired and then reassembled and used to untighten the screws or bolts.

Moreover, as illustrated in FIGS. 1 to 3, the neck 200 is equipped with a plurality of heads 210 wherein a plurality of string winding members 211 are installed at previously set positions of one side thereof, and the other side thereof is engaged to the neck engaging unit 140 by an engaging method.

The configurations of the heads 210 can be manufactured by a typical method, so the detailed descriptions thereon will be omitted.

As illustrated in FIGS. 1 and 3, the fingerboard 300 may include a plurality of flats 310 which are arranged at previously set intervals, and the intervals and number of the flats 310 may be determined by a typical method.

Moreover, the fingerboard 310 may be made, by a die casting method, of a magnesium alloy like the body 100 and the neck 200. It may be manufactured using a wooden material, a synthetic resin, etc.

In the present invention, since the body and the neck are made hollow, by a die casting method, of a magnesium alloy, the weight of the electric guitar can be reduced, and the hollow portions may function like a sound box of a typical guitar, for example, a nylon guitar, so it is possible to make acoustics which are different from a typical electric guitar.

Moreover, in the present invention, since the neck can be separated from the body, only the neck or the body can be exchanged or repaired and then reassembled and used.

### MODES FOR CARRYING OUT THE INVENTION

As illustrated in FIG. 4, the lightness electric guitar according to a second embodiment of the present invention may be configured same to or similar with the configuration of the first embodiment of the present invention, except for the configuration of a neck 200′. The same components as the first embodiment of the present invention will be given the same reference numbers, and the detailed descriptions thereon will be omitted. The configuration of only the neck 200′ will be described.

As illustrated in FIG. 4, the neck 200′ according to the second embodiment of the present invention may be formed of a part which is configured to support the fingerboard 300, and a head 210′ which is able to support strings. The head 210′ may be engaged by a method, for example, a melting and adhering method, an attaching method, etc. Preferably, it is attached using an engaging method, by which the neck 200′ as well as the head 210′ can be exchanged, if necessary, and can be used.

The head 210′ can be separated from the neck 200′. For this reason, if a part which defines the head 210′ is deformed or the head 210′ needs to be exchanged since it is broken, etc., the head 210′ can be repaired or exchanged. If an owner of the electric guitar according to the present invention wants to selectively exchange the heads 210′ which have been manufactured in various shapes based on his preference, the heads 210′ can be selectively exchanged as well.

1. A lightness electric guitar, comprising:
a body 100 which is made of a magnesium alloy and in a hollow form 150 by a die casting method and is equipped with a bridge assembly 110, a pickup 120 and an adjusting unit 130 all disposed at one side thereof, and a neck engaging unit 140 disposed at another side thereof;
a neck 200 which is made, in a hollow form 220, of a magnesium alloy and is installed detachable at the neck engaging unit 140; and
a fingerboard 300 which is mounted on the neck 200.

2. The guitar of claim 1, wherein the surfaces of the body 100 and the neck 200 are plated with a nickel material.

3. The guitar of claim 1, wherein the body 100 and the neck 200 are manufactured by a MCT (Machining Center Tooling) processing method.

4. The guitar of claim 1, wherein the insides of the body 100 and the neck 200 are processed to have vacuums.

5. The guitar of claim 1, wherein the neck 200 is engaged detachable using screws or bolts and nuts.

6. The guitar of claim 1, wherein a head 210 is engaged detachable, using screws or bolts and nuts, to the neck 200, the head 210 being configured to fix an end of each string.
